(19) United States
(12) Patent Application Publication
(10) Pub. No.: US 2014/0192300 A1
(43) Pub. Date: Jul. 10, 2014

(54) Compensation System for Liquid Crystal Panel and Liquid Crystal Display Device

(71) Applicants: Chih-tsung Kang, Shenzhen City (CN); Bo Hai, Shenzhen City (CN)

(72) Inventors: Chih-tsung Kang, Shenzhen City (CN); Bo Hai, Shenzhen City (CN)

(73) Assignee: Shenzhen China Star Optoelectronics Technology Co.,Ltd., Shenzhen, Guangdong (CN)

(21) Appl. No.: 13/810,463

(22) PCT Filed: Jan. 11, 2013
(86) PCT No.: PCT/CN2013/070379

§ 371 Date: Jan. 16, 2013

(30) Foreign Application Priority Data
Jan. 9, 2013 (CN) 201310007722.5

(51) Int. Cl. G02F 1/1335; G02B 5/30

(52) U.S. Cl. CPC G02F 1/1335; G02F 1/133528; G02B 5/3083
USPC 349/102; 349/119; 349/96; 359/489.02

(57) ABSTRACT

The present invention provides a compensation system for liquid crystal panel and liquid crystal display device. The compensation system includes first biaxial compensation film and second biaxial compensation film, disposed on two sides of liquid crystal panel respectively, first biaxial compensation film having planar compensation value Ro1 for incident light of 550 nm wavelength and compensation value Rth1 along thickness direction, second biaxial compensation film having planar compensation value Ro2 for incident light of 550 nm wavelength and compensation value Rth2 along thickness direction; wherein 15 nm≦Ro1≦94 nm; 35 nm≦Rth1≦214 nm; 35 nm≦Rth1≦214 nm; 14 nm≦Ro2≦101 nm; Y1≦Rth2≦Y2; Y1=0.004302×Rth1²−1.96894×Rth1+259.7; Y2=−0.00234308×Rth1²−0.32227×Rth1+245. As such, the present invention effectively reduces dark state light leakage of liquid crystal panel by disposing biaxial compensation films of appropriate compensation values.

### BACKGROUND OF THE INVENTION

1. Field of the Invention

The present invention relates to the field of liquid crystal displaying techniques, and in particular to a compensation system for liquid crystal panel and liquid crystal display device.

2. The Related Arts

As the technology progresses, the liquid crystal display device becomes the mainstream display device. However, as the viewing angle of the liquid crystal display device increases, the contrast of the image as well as the clarity of the image also decreases, which is a result of change of birefringence of the liquid crystal molecules in the liquid crystal layer caused by the changes of viewing angle. If wide-angle compensation film is used to compensate, the light leakage of the dark state image can be effectively reduced and the contrast f the image can be greatly improved in a certain viewing angle range. The theory of the compensation film is to perform correction on the phase difference caused by the liquid crystal at different viewing angles so that the birefringence of the liquid crystal molecules can obtain symmetrical compensation. For different liquid crystal display modes, different compensation films are used. The compensation film used by large-size liquid crystal TV are mostly targeting VA display mode, whose compensation structure is mainly monolayer biaxial compensation film or double-layer biaxial compensation film. For different liquid crystal optical path difference Δn×d, the compensation value of the compensation film required to achieve minimal dark state light leakage is also different. It not matched properly, the liquid crystal display device will not only generate dark state light leakage at large viewing angle in the dark state, but also affect the contrast of the large viewing angle and clarity of viewing.

Referring to FIG. 1 and FIG. 2, FIG. 1 is a simulated view of the dark state light leakage distribution after compensated by double-layer biaxial compensation film, and FIG. 2 is distribution analogy view of full angle contrast after compensated by double-layer biaxial compensation film, wherein the liquid crystal optical path difference Δn×d is 324.3 nm, the planar compensation value Ro of the double-layer biaxial compensation film is both 70 nm and the compensation value Ro of the double-layer biaxial compensation film along the thickness direction is both 160 nm. As shown in FIG. 1 and FIG. 2, under the above conditions, the light leakage in areas of orientation angles after compensated by the double-layer biaxial compensation film are 30°-60°, 120°-150°, 210°-240° and 300°-330° is still severe, and, as a result, the contrast at these view angles is low.

Thus, it is desired to have a compensation system for liquid crystal panel and liquid crystal display device that overcomes the above problems.

### SUMMARY OF THE INVENTION

The technical issue to be addressed by the present invention is to provide a compensation system for liquid crystal panel and liquid crystal display device to effectively reduce the dark state light leakage phenomenon in the liquid crystal panel.

The present invention provides a compensation system for liquid crystal panel, which comprises: a first biaxial compensation film and a second biaxial compensation film, disposed on two sides of the liquid crystal panel respectively, the first biaxial compensation film having a planar compensation value Ro1 for incident light of 550 nm wavelength and a compensation value Rth1 along thickness direction, the second biaxial compensation film having a planar compensation value Ro2 for incident light of 550 nm wavelength and a compensation value Rth2 along thickness direction; wherein

15 nm≦Ro1≦94 nm;

35 nm≦Rth1≦214 nm;

14 nm≦Ro2≦101 nm;

Y1≦Rth2≦Y2;

Y1=0.004302×Rth1²−1.96894×Rth1+259.7;

Y2=−0.00234308×Rth1²−0.32227×Rth1+245.

According to a preferred embodiment of the present invention, 104 nm≦Rth1=Rth2≦147.2 nm.

According to a preferred embodiment of the present invention, the liquid crystal optical path difference Δn×d of the liquid crystal panel is: 305.8 nm≦Δn×d≦324.3 nm.

The present invention provides a liquid crystal display device, which comprises: a liquid crystal panel, disposed with a liquid crystal layer having a plurality of liquid crystal molecules, the liquid crystal layer having a refractive index anisotropy Δn for incident light of 550 nm wavelength, a thickness d and pretilt angle θ; a first biaxial compensation film and a second biaxial compensation film, disposed on two sides of the liquid crystal panel respectively, the first biaxial compensation film having a planar compensation value Ro1 for incident light of 550 nm wavelength and a compensation value Rth1 along thickness direction, the second biaxial compensation film having a planar compensation value Ro2 for incident light of 550 nm wavelength and a compensation value Rth2 along thickness direction; wherein

305.8 nm≦Δn×d≦324.3 nm;

85°≦θ≦90°;

15 nm≦Ro1≦94 nm;

35 nm≦Rth1≦214 nm;

14 nm≦Ro2≦101 nm;

Y1≦Rth2≦Y2;

Y1=0.004302×Rth1²−1.96894×Rth1+259.7;

Y2=−0.00234308×Rth1²−0.32227×Rth1+245.

According to a preferred embodiment of the present invention, 104 nm≦Rth1=Rth2≦147.2 nm.

According to a preferred embodiment of the present invention, the liquid crystal display device further comprises a first polarizing film and a second polarizing film, disposed on two sides of the liquid crystal panel respectively; the first polarizing film and the first biaxial compensation film are located on one side of the liquid crystal panel, and the second polarizing film and the second biaxial compensation film are located on the other side of the liquid crystal panel.

According to a preferred embodiment of the present invention, the absorption axis of the first polarizing film forms 90° with the slow axis of the first biaxial compensation film, and the absorption axis of the second polarizing film forms 90° with the slow axis of the second biaxial compensation film.

According to a preferred embodiment of the present invention, the first polarizing film and a second polarizing film are polyvinyl alcohol (PVA) films.

According to a preferred embodiment of the present invention, the first biaxial compensation film is disposed between the first polarizing film and the liquid crystal panel; the second biaxial compensation film is disposed between the second polarizing film and the liquid crystal panel.

According to a preferred embodiment of the present invention, the liquid crystal panel is a vertical alignment (VA) cell.

The efficacy of the present invention is that to be distinguished from the state of the art. Through appropriate compensation values of the double-layer biaxial compensation film, the present invention can effectively reduce the dart state light leakage of the liquid crystal panel and effectively improve the contrast and clarity at large viewing angle (not horizontally, but vertically) to improve the viewing range.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a simulated view of the dark state light leakage distribution after compensated by double-layer biaxial compensation film;

FIG. 2 is distribution analogy view of full angle contrast after compensated by double-layer biaxial compensation film;

FIG. 3 is a schematic view showing the structure of a liquid crystal display device of the first embodiment according to the present invention;

FIG. 4 is a schematic view showing the structure of a liquid crystal panel of the first embodiment according to the present invention;

FIG. 5 is a schematic view showing the slow axis of the first biaxial compensation film and the absorption axis of the first polarizing film in the first embodiment according to the present invention;

FIG. 6 is a schematic view showing the slow axis of the second biaxial compensation film and the absorption axis of the second polarizing film in the first embodiment according to the present invention;

FIG. 7 is a view showing the trend of the dark state light leakage as the compensation value changing of the liquid crystal display device of the first embodiment according to the present invention at liquid crystal optical path difference=305.8 nm;

FIG. 8 is a view showing the trend of the dark state light leakage as the compensation value changing of the liquid crystal display device of the first embodiment according to the present invention at liquid crystal optical path difference=324.3 nm;

FIG. 9 is a view showing the trend of the dark state light leakage as the compensation value changing of the liquid crystal display device of the second embodiment according to the present invention at liquid crystal optical path difference=305.8 nm;

FIG. 10 is a view showing the trend of the dark state light leakage as the compensation value changing of the liquid crystal display device of the second embodiment according to the present invention at liquid crystal optical path difference=324.3 nm;

FIG. 11 is a view showing the dark state light leakage distribution after compensated by compensation system of the embodiment according to the present invention; and

FIG. 12 is a view showing the full view angle contrast distribution after compensated by compensation system of the embodiment according to the present invention.

### DETAILED DESCRIPTION OF THE PREFERRED EMBODIMENTS

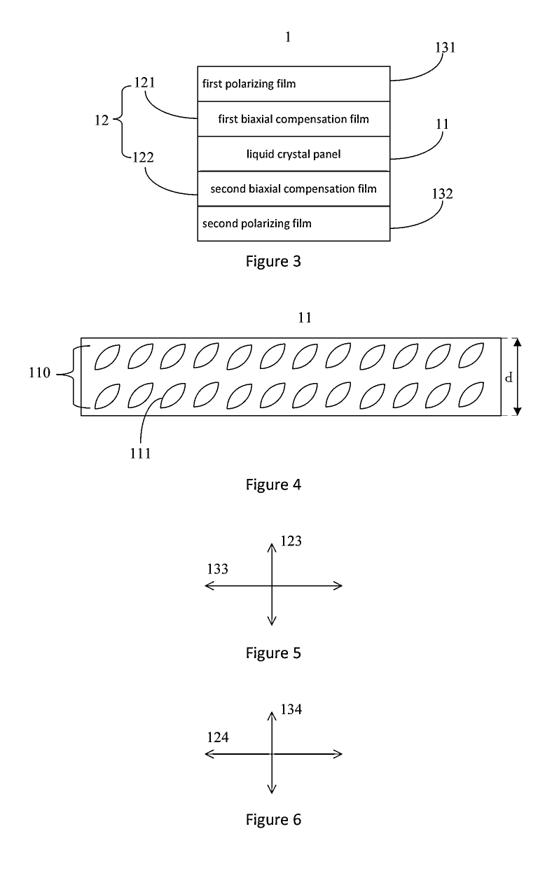

Referring to FIG. 3, FIG. 3 is a schematic view showing the structure of a liquid crystal display device of the first embodiment according to the present invention. In the instant embodiment, the liquid crystal display device 1 comprises: liquid crystal panel 11, compensation system 12 and first polarizing film 131 and second polarizing film 132.

In the instant embodiment, the liquid crystal panel 11 is a vertical alignment (VA) cell. Further referring to FIG. 4, FIG. 4 is a schematic view showing the structure of a liquid crystal panel of the first embodiment according to the present invention. The liquid crystal panel 11 is disposed with a liquid crystal layer 110 having a plurality of liquid crystal molecules 111. The liquid crystal layer has a refractive index anisotropy Δn for incident light of 550 nm wavelength, a thickness d, a liquid crystal optical path difference Δn×d and pretilt angle θ, wherein 305.8 nm≦Δn×d≦324.3 nm, and 85°≦θ≦90°.

Compensation system 12 comprises a first biaxial compensation film 121 and a second biaxial compensation film 122. The first biaxial compensation film 121 and the second biaxial compensation film 122 are disposed on two sides of the liquid crystal panel respectively. The first polarizing film 131 and the first biaxial compensation film 121 are located on the same side of the liquid crystal panel 11. Referring to FIG. 5, FIG. 5 is a schematic view showing the slow axis of the first biaxial compensation film and the absorption axis of the first polarizing film in the first embodiment according to the present invention. The absorption axis 133 of the first polarizing film 131 forms 90° with the slow axis 123 of the first biaxial compensation film 121. The second polarizing film 132 and the second biaxial compensation film 122 are located on the same side of the liquid crystal panel 11. Referring to FIG. 6, FIG. 6 is a schematic view showing the slow axis of the second biaxial compensation film and the absorption axis of the second polarizing film in the first embodiment according to the present invention. The absorption axis 134 of the second polarizing film 132 forms 90° with the slow axis 124 of the second biaxial compensation film 122. The first polarizing film 131 and the second polarizing film 132 are polyvinyl alcohol (PVA) films.

As shown in FIG. 3, the first biaxial compensation film 121 is disposed between the first polarizing film 131 and the liquid crystal panel 11; the second biaxial compensation film 122 is disposed between the second polarizing film 132 and the liquid crystal panel 11.

The first biaxial compensation film 121 has a planar compensation value Ro1 for incident light of 550 nm wavelength and a compensation value Rth1 along thickness direction. The second biaxial compensation film 122 has a planar compensation value Ro2 for incident light of 550 nm wavelength and a compensation value Rth2 along thickness direction.

In the first embodiment, to effectively reduce the dark state light leakage phenomenon of the liquid crystal panel, the compensation values of the first biaxial compensation film 121 and the second biaxial compensation film 122 to achieve the optimal compensation result. In the simulated process, the first embodiment further sets the pretilt angles of the liquid crystal in the four quadrants as 45°, 135°, 225° and 315°. The light source is blue-YAG LED, with the central luminance of the spectrum as 100 nit and the light source distribution is Lambert's distribution.

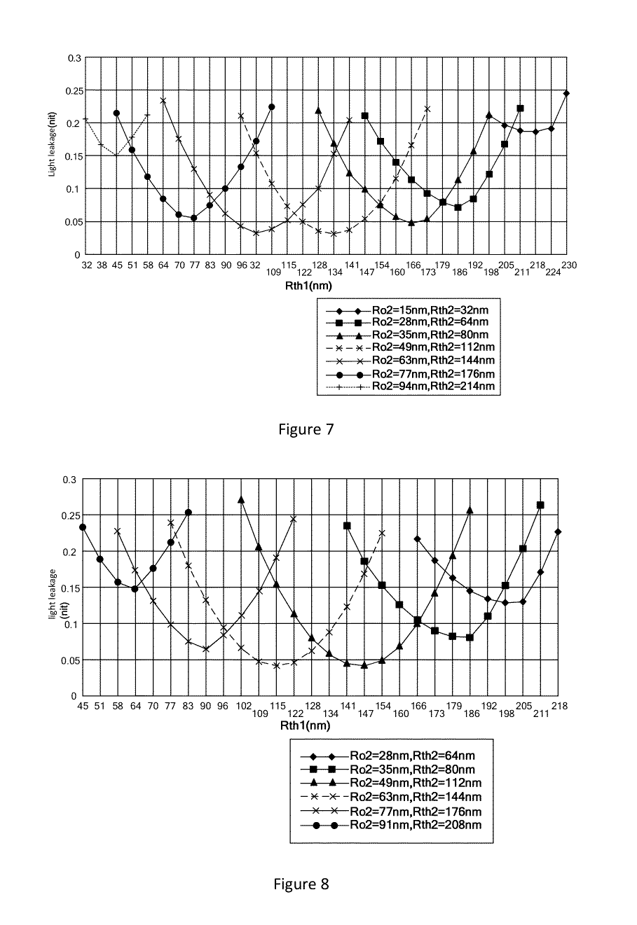

Referring to FIG. 7 and FIG. 8, FIG. 7 is a view showing the trend of the dark state light leakage as the compensation value changing of the liquid crystal display device of the first embodiment according to the present invention at liquid crystal optical path difference=305.8 nm; FIG. 8 is a view showing the trend of the dark state light leakage as the compensation value changing of the liquid crystal display device of the first embodiment according to the present invention at liquid crystal optical path difference=324.3 nm. Under the condition of different pretilt angles, the compensation values of the first biaxial compensation film 121 and the second biaxial compensation film 122 have similar effect trends on the dark state light leakage. In other words, at different pretilt angles, the range of compensation value corresponding to the minimal dark state light leakage is the same. Therefore, through FIG. 7 and FIG. 8, simulation is conducted for different pretilt angles in combination with different compensation values to obtain that, under the condition of 305.8 nm≦Δn×d≦324.3 nm, 85°≦θ≦90°, and dark state light leakage<0.2 nit, the ranges of the compensation values of the first biaxial compensation film 121 and the second biaxial compensation film 122 are:

15 nm≦Ro1≦94 nm;

35 nm≦Rth1≦214 nm;

14 nm≦Ro2≦101 nm;

Y1≦Rth2≦Y2;

wherein

Y1=0.004302×Rth1²−1.96894×Rth1+259.7;

Y2=−0.00234308×Rth1²−0.32227×Rth1+245.

The planar compensation values Ro1 and Ro2 of the first biaxial compensation film 121 and the second biaxial compensation film 122, and the compensation values Rth1 and Rth2 along the thickness direction are all compensation values for incident light of wavelength 550 nm. When the compensation values are within the above ranges, the liquid crystal display device can obtain optimal compensation result to achieve the minimal dark state light leakage.

In industrial manufacturing, the first biaxial compensation film 121 and the second biaxial compensation film 122 often are the same compensation film to make the manufacturing process easier and faster. Therefore, in the second embodiment, the first biaxial compensation film 121 and the second biaxial compensation film 122 are designed to have the same compensation value range.

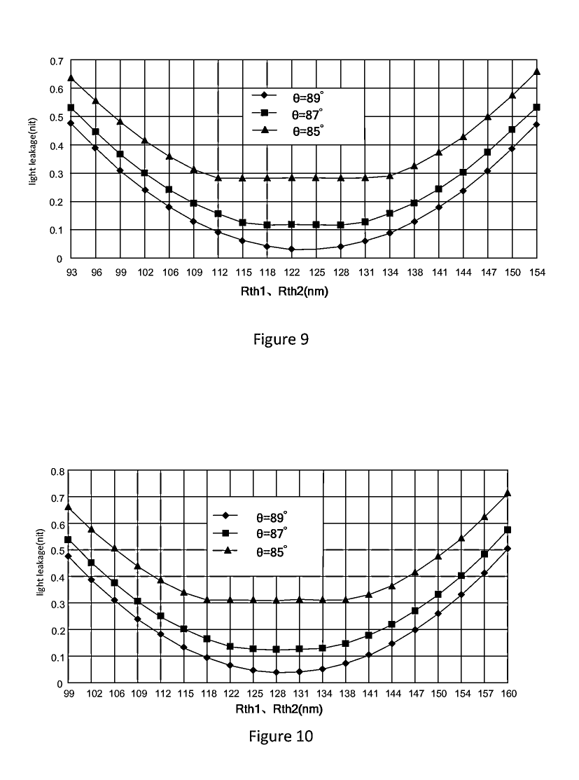

Referring to FIG. 9 and FIG. 10, FIG. 9 is a view showing the trend of the dark state light leakage as the compensation value changing of the liquid crystal display device of the second embodiment according to the present invention at liquid crystal optical path difference=305.8 nm; FIG. 10 is a view showing the trend of the dark state light leakage as the compensation value changing of the liquid crystal display device of the second embodiment according to the present invention at liquid crystal optical path difference=324.3 nm.

Similarly, through FIG. 9 and FIG. 10, simulation is conducted for different pretilt angles in combination with different compensation values. At different pretilt angles, the range of compensation value corresponding to the minimal dark state light leakage is the same. Therefore, under the condition of 305.8 nm≦Δn×d≦324.3 nm, 85°≦θ≦90°, dark state light leakage<0.2 nit, and compensation values Rth1 Rth2 along the thickness direction the same, the ranges of the compensation values are 104 nm≦Rth1=Rth2≦147.2 nm.

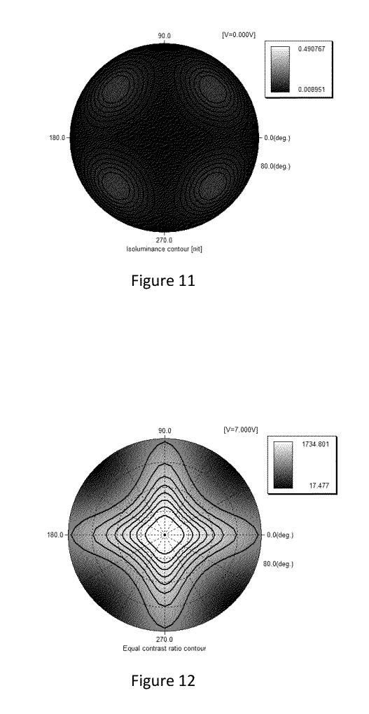

Referring to FIG. 11 and FIG. 12, FIG. 11 is a view showing the dark state light leakage distribution after compensated by compensation system of the embodiment according to the present invention; FIG. 12 is a view showing the full view angle contrast distribution after compensated by compensation system of the embodiment according to the present invention. The conditions for FIG. 11 and FIG. 12 are: Δn×d=324.3 nm, θ=89°, planar compensation values Ro1, Ro2 of the first biaxial compensation film 121 and the second biaxial compensation film 122 are Ro1=Ro2=62 nm, and the compensation values along the thickness direction of the first biaxial compensation film 121 and the second biaxial compensation film 122 are Rth1=Rth2=141 nm.

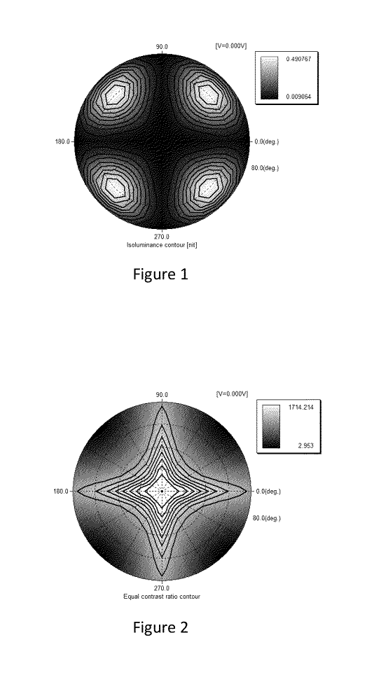

Comparing FIG. 11 against FIG. 1, the dark state light leakage after compensated by the compensation system of the embodiment of the present invention is far less than the dark state light leakage after compensated by the known double-layer biaxial compensation film. Comparing FIG. 12 against FIG. 2, the full view angle contrast distribution after compensated by the compensation system of the embodiment of the present invention is far better than the full view angle contrast distribution after compensated by the known double-layer biaxial compensation film.

Those with ordinary skills in the related field can easily obtain the biaxial compensation film of the above compensation value range by changing the thickness or refractive index of the known double-layer biaxial compensation film. Specifically, the planar compensation value Ro of the biaxial compensation film and the compensation value Rth along the thickness direction, refractive index N (comprising Nx, Ny in the plane of biaxial compensation film and Nz long the thickness direction of the biaxial compensation film) and the thickness d must satisfy the following:

Ro=(Nx−Ny)×d

Rth=[(Nx+Ny)/2−Nz]×d

Accordingly, the planar compensation value Ro of the biaxial compensation film and the compensation value Rth along the thickness direction can be changed by many means. For example, with fixed refractive index N, the compensation values can be changed by changing thickness d. Alternatively, with fixed thickness d, the compensation values can be changed by changing refractive index N. Of course, the compensation values can be changed by changing both thickness d and refractive index N.

The present invention further provides a compensation system for liquid crystal panel.

Those with ordinary skills in the related field can easily effectively reduce the dark state light leakage phenomenon in liquid crystal panel by modifying the first embodiment of the present invention, for example, by switching the first biaxial compensation film 121 and the second biaxial compensation film 122 and use the compensation value ranged designed by the present invention. The present invention does not impose any specific location of the double-layer biaxial compensation film, as long as satisfying the above compensation value ranges to achieve better compensation result.

Through appropriate compensation values of the double-layer biaxial compensation film, the present invention can effectively reduce the dart state light leakage of the liquid crystal panel and effectively improve the contrast and clarity at large viewing angle (not horizontally, but vertically) to improve the viewing range.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A compensation system for liquid crystal panel, which comprises: a first biaxial compensation film and a second biaxial compensation film, disposed on two sides of the liquid crystal panel respectively, the first biaxial compensation film having a planar compensation value Ro1 for incident light of 550 nm wavelength and a compensation value Rth1 along thickness direction, the second biaxial compensation film having a planar compensation value Ro2 for incident light of 550 nm wavelength and a compensation value Rth2 along thickness direction;
wherein:
15 nm≦Ro1≦94 nm;
35 nm≦Rth1≦214 nm;
35 nm≦Rth1≦214 nm;
14 nm≦Ro2≦101 nm;
Y1≦Rth2≦Y2;
Y1=0.004302×Rth1²−1.96894×Rth1+259.7;
Y2=−0.00234308×Rth1²−0.32227×Rth1+245.

2. The compensation system for liquid crystal display device as claimed in claim 1, characterized in that 104 nm≦Rth1=Rth2≦147.2 nm.

3. The compensation system for liquid crystal display device as claimed in claim 1, characterized in that the liquid crystal optical path difference Δn×d of the liquid crystal panel is: 305.8 nm≦Δn×d≦324.3 nm.

4. A liquid crystal display device, which comprises:
a liquid crystal panel, disposed with a liquid crystal layer having a plurality of liquid crystal molecules, the liquid crystal layer having a refractive index anisotropy Δn for incident light of 550 nm wavelength, a thickness d and pretilt angle θ:
a first biaxial compensation film and a second biaxial compensation film, disposed on two sides of the liquid crystal panel respectively, the first biaxial compensation film having a planar compensation value Ro1 for incident light of 550 nm wavelength and a compensation value Rth1 along thickness direction, the second biaxial compensation film having a planar compensation value Ro2 for incident light of 550 nm wavelength and a compensation value Rth2 along thickness direction;
wherein
305.8 nm≦Δn×d≦324.3 nm;
85°≦θ≦90°;
15 nm≦Ro1≦94 nm;
35 nm≦Rth1≦214 nm;
35 nm≦Rth1≦214 nm;
14 nm≦Ro2≦101 nm;
Y1≦Rth2≦Y2;
Y1=0.004302×Rth1²−1.96894×Rth1+259.7;
Y2=−0.00234308×Rth1²−0.32227×Rth1+245.

5. The liquid crystal display device as claimed in claim 4, characterized in that 104 nm≦Rth1=Rth2≦147.2 nm.

6. The liquid crystal display device as claimed in claim 4, characterized in that the liquid crystal display device further comprises a first polarizing film and a second polarizing film, disposed on two sides of the liquid crystal panel respectively; the first polarizing film and the first biaxial compensation film are located on one side of the liquid crystal panel, and the second polarizing film and the second biaxial compensation film are located on the other side of the liquid crystal panel.

7. The liquid crystal display device as claimed in claim 6, characterized in that the absorption axis of the first polarizing film forms 90° with the slow axis of the first biaxial compensation film, and the absorption axis of the second polarizing film forms 90° with the slow axis of the second biaxial compensation film.

8. The liquid crystal display device as claimed in claim 6, characterized in that the first polarizing film and a second polarizing film are polyvinyl alcohol (PVA) films.

9. The liquid crystal display device as claimed in claim 6, characterized in that the first biaxial compensation film is disposed between the first polarizing film and the liquid crystal panel; the second biaxial compensation film is disposed between the second polarizing film and the liquid crystal panel.

10. The liquid crystal display device as claimed in claim 4, characterized in that the liquid crystal panel is a vertical alignment (VA) cell.
